(19) United States
(12) Patent Application Publication
(10) Pub. No.: US 2024/0351013 A1
(43) Pub. Date: Oct. 24, 2024

(54) CATALYST SUPPORT

(71) Applicant: JEMMTEC LIMITED, Dewsbury (GB)

(72) Inventors: Mark Stuckey, Dewsbury (GB); Richard CAULKIN, Dewsbury (GB); Tom CORNELIUS, Dewsbury (GB)

(21) Appl. No.: 18/033,921

(22) PCT Filed: Nov. 1, 2021
(86) PCT No.: PCT/GB2021/052827

§ 371 Date: Apr. 26, 2023

(30) Foreign Application Priority Data
Oct. 30, 2020 (GB) 2017254.0

(51) Int. Cl. B01J 35/51; B01J 35/31; B01J 35/60; B01J 37/00; B01J 37/08; B01J 37/12

(52) U.S. Cl. CPC B01J 35/51; B01J 35/31; B01J 35/60; B01J 37/0009; B01J 37/08; B01J 37/12; B01J 2219/30416

(57) ABSTRACT

A support for a catalyst. The support is for use in a packed-bed reactor for the production of an alkylene oxide. The support includes ceramic material and the support has a substantially spherical or ellipsoidal macrostructure. The support further includes surface structures and has a porosity of ≥0.35 cm³/g. The catalyst may be included in an apparatus and used for the production of an alkylene oxide.

### FIELD

The present invention relates to a support for a catalyst and a supported catalyst. More specifically, the present invention relates to a support and a supported catalyst for use in the production of an alkylene oxide. The invention extends to a method for the production of an alkylene oxide using the catalyst.

### BACKGROUND

Ethylene oxide is an important industrial chemical, used as a disinfectant, sterilizing agent, and fumigant as well as an intermediate in the production of ethylene glycol, poly(ethylene glycols) and various amines.

Ethylene oxide is produced in large quantities worldwide by the direct catalytic oxidation of ethylene using either oxygen or air in the presence of a silver catalyst. This oxidation reaction occurs readily but will easily progress further than desired fully oxidising both the feed ethylene and product ethylene oxide to a mixture of carbon dioxide and water. Therefore, the main focus of a catalyst in this process is the selectivity, the ability to produce as much of the desirable ethylene oxide as possible with the minimum carbon dioxide and water.

Typically, the catalysts used in this process would be a supported silver catalyst with approximately 7-20% silver. The catalyst shape is generally produced via an extruded ceramic paste or dough which is then dried and calcined to a temperature sufficient to provide the strength needed.

A catalyst support having a high specific surface area can increase activity and allow higher volumes to be produced, however using the common catalyst production methods increasing the surface area is usually achieved by decreasing pore diameter and thereby losing the selectivity needed. To increase the surface area, it is common to decrease the size of the support pellets, however this will increase the pressure drop through a packed bed, which is limited by the capability of the production plant.

Therefore, there is a requirement for a further improved catalyst for use in the production of an alkylene oxide. It is therefore an object of aspects of the present invention to address one or more of the above-mentioned, or other, problems.

### SUMMARY

According to a first aspect of the present invention there is provided a support for a catalyst, wherein the support has a substantially spherical or ellipsoidal macrostructure and comprises surface structures, and wherein the support has a porosity of ≥0.35 cm³/g, preferably ≥0.40 cm³/g, more preferably ≥20.45 cm³/g, most preferably ≥20.50 cm³/g.

The support may be for a catalyst for use in a packed-bed reactor for the production of an alkylene oxide. The support may further be in the form of a supported catalyst by further comprising catalytic material. The support may also be in the form of an inert packing member wherein suitably the support is substantially free of catalyst material.

According to a second aspect of the present invention there is provided a supported catalyst for use in a packed-bed reactor for the production of an alkylene oxide, wherein the supported catalyst comprises ceramic material, and wherein the supported catalyst has a substantially spherical or ellipsoidal macrostructure and comprises surface structures.

The support/supported catalyst suitably has a macrostructure and surface structures on the outer face of the macrostructure.

The spherical or ellipsoidal macrostructure may comprise at least one linear groove on the outer face of the macrostructure, such as at least two, at least three or at least four linear grooves. Preferably, the spherical or ellipsoidal macrostructure comprises at least two linear parallel grooves, such as at least three or at least four. Preferably, the grooves are substantially hemispherical in a lateral cross-section. When a spherical or ellipsoidal macrostructure comprises such a linear groove the macrostructure can be considered to be a grooved sphere or ellipsoid.

The macrostructure may substantially be in the form of a sphere.

The support/supported catalyst may not comprise a fluid communication intra-particle channel extending through the support/supported catalyst from a first aperture on a first side of the support/supported catalyst to a second aperture on a substantially opposing second side of the support/supported catalyst.

When the support/supported catalyst does not comprise a fluid communication intra-particle channel, fluid may substantially not be able to flow through the support/supported catalyst in use from a first side of the support/supported catalyst to a substantially opposite second side of the support/supported catalyst. Accordingly, to pass the support/supported catalyst fluid may be forced to flow around the outer surface of the support/supported catalyst. As such, in the context of the present invention, the phrase “does not comprise a fluid communication intra-particle channel extending through the support/supported catalyst from a first aperture on a first side of the support/supported catalyst to a second aperture on a substantially opposing second side of the support/supported catalyst” may be interpreted to mean that substantially no fluid flow is achieved through the body of the support/supported catalyst in use from a first side of the support/supported catalyst to a substantially opposite second side of the support/supported catalyst. It will be understood that such “fluid communication intra-particle channels” in the context of the present invention do not include microscopic porosity that may be present in the material of the support/supported catalyst.

The support/supported catalyst may comprise no fluid communication intra-particle channels in the support/supported catalyst extending from a first aperture to a second aperture.

Advantageously, it has surprisingly been found that the combination of surface structures with the absence of a flow channel through the body of the support/supported catalyst leads to increased strength while also increasing flow speed, directing flow over the surface and providing a more uniform flow for the production of an alkylene oxide.

The support/supported catalyst may have a largest dimension of up to 20 mm, such as up to 17 mm or up to 12 mm, or up to 9 mm, or up to 7 mm or up to 6 mm.

The height, suitably the mean average height, of the surface structures of the support/supported catalyst may be up to 30% of the largest dimension of the support/supported catalyst, such as up to 20%, preferably up to 15%.

By “surface structures” it is meant structures that represent a deviation of the shape of the outer surface of the support/supported catalyst from the shape that would be expected based on the macrostructure of the support/supported catalyst. Such surface structures may be significantly smaller than the size of the features of the macrostructure of the support/supported catalyst. The surface structures may be considered to be surface texturing on the macrostructure of the support/supported catalyst. It will be understood that such “surface structures” in the context of the present invention do not include microscopic surface roughness.

For example, the support/supported catalyst may have a spherical macrostructure with a diameter of 10 mm. The outer surface of the said support/supported catalyst is partially consistently curved as would be expected for a spherical macrostructure, but the outer surface of the support/supported catalyst also comprises a plurality of surface structures that deviate from the expected curved shape of the outer surface in the form of 12 discrete mounds wherein each mound has a height of 2 mm.

It will be appreciated that normal features of macrostructures such as the castellations of a cog or the lobes of multilobe are considered to be part of the macrostructure and are not considered to be surface structures according to the present invention.

The support/supported catalyst may comprise surface structures on at least two sides of the support/supported catalyst.

The support/supported catalyst may comprise surface structures extending over ≥20% of the outer surface of the support/supported catalyst, such as over ≥30%, ≥40%, ≥60% or ≥80% of the outer surface.

By “comprise surface structures extending over”, it is meant that at least the specified percentage of the outer surface of the support/supported catalyst deviates from the expected shape of the outer surface of the support/supported catalyst based on the macrostructure. It will be appreciated that the amount of the surface that deviates is calculated based on the surface area of the expected shape of the outer surface, and missing portions thereof, rather than on the surface area of the surface structures. For example, the support/supported catalyst may have a spherical macrostructure with an expected outer surface area of 314 cm², of which 200 cm² deviates from the expected consistent curvature of a spherical macrostructure, and as such the support/supported catalyst comprises surface structures extending over 63% of the outer surface. For the purposes of this calculation, the expected outer surface area that is occupied by any apertures connecting a fluid communication channel is added to the sum of the remaining expected outer surface area.

The height, suitably the mean average height, of the surface structures of the support/supported catalyst may be ≤10 mm, preferably ≤7 mm, more preferably ≤6 mm, most preferably ≤5 mm. The height, suitably the mean average height, of the surface structures of the support/supported catalyst may be ≥0.1 mm, such as ≥0.3 mm, preferably ≥0.5 mm, more preferably ≥0.7 mm, most preferably ≥0.8 mm. The height of the surface structures herein is measured using callipers with a depth measurement function. It will be appreciated that “height” in this context refers to the distance from the lowest point of the surface structure to the highest point of the surface structure.

The support/supported catalyst may comprise a plurality of repeating surface structures having substantially the same shape. Preferably, the support/supported catalyst comprises at least 5 repeating surface structures, more preferably at least 10, such as at least 15, or at least 20, most preferably at least 25.

A surface structure may in the form of a ridge, trough, mound and/or depression.

A surface structure in the form of a ridge or trough is typically elongate and may be in the form of an annular ridge/trough, wherein said annular ridge/trough is not restricted to a circular ring shape. The annular ridge/trough may be in the form of a substantially circular shape or a regular convex polygon, such as a triangle, square, pentagon, hexagon, heptagon, octagon, nonagon, or decagon, Preferably the annular ridge/trough is the form of a regular convex polygon, more preferably pentagon, hexagon or heptagon, most preferably hexagon. The portion of the outer surface that is contained within an annular ridge/trough may be according to the expected shape of the outer surface of the supported catalyst or may be flat, sloped and/or curved. For example, the portion of the outer surface contained within an annular ridge may be in the form of an inverted pyramid. The surface structures may comprise a plurality of connected annular ridge/trough structures, suitably interconnected annular ridge/trough structures such that a ridge of at least a first annular surface structure forms part of a second annular surface structure.

A surface structure in the form of a mound or depression may be a curved, pyramidal and/or stepped mound/depression. A stepped mound/depression may comprise between 2 to 10 steps, such as between 3 and 8 steps. The mound or depression may interconnect such that adjacent mounds/depressions abut or are merged together.

The support/supported catalyst, such as a support/supported catalyst having a diameter or largest dimension of ≥8 mm, or >9 mm, such as ≤17 mm to ≥8 mm, or packed bed, may have a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³.

The support/supported catalyst, such as a support/supported catalyst having a diameter or largest dimension of ≥8 mm, or >9 mm, such as ≤17 mm to ≥8 mm, may have a side crush strength of ≥10 kgf, such as ≥12 kgf, preferably ≥15 kgf, and/or may have a side crush strength of ≥50 kgf, such as ≥60 kgf, preferably ≥70 kgf, more preferably ≥80 kgf, most preferably ≥85 kgf.

The support/supported catalyst, such as a support/supported catalyst having a diameter or largest dimension of ≤9 mm, such as ≤9 mm to ≥7 mm, or packed bed, may have a GSA of ≥1.3 cm²/cm³, such as ≥1.4 cm²/cm³, preferably a GSA of ≥1.5 cm²/cm³, more preferably a GSA of ≥1.6 cm²/cm³, most preferably a GSA of ≥1.7 cm²/cm³.

The support/supported catalyst, such as a support/supported catalyst having a diameter or largest dimension of ≤9 mm, such as ≤9 mm to ≥7 mm, may have a side crush strength of ≥8 kgf, such as ≥10 kgf, preferably ≥12 kgf, and/or may have a side crush strength of ≥30 kgf, preferably ≥50 kgf, more preferably ≥60 kgf, most preferably ≥70 kgf or ≥80 kgf.

The support/supported catalyst, such as a support/supported catalyst having a diameter or largest dimension of ≤7 mm, such as ≤7 mm to ≥5 mm, or packed bed, may have a GSA of ≥1.7 cm²/cm³, such as ≥1.8 cm²/cm³, preferably a GSA of ≥1.9 cm²/cm³, more preferably a GSA of ≥2.0 cm²/cm³, most preferably a GSA of ≥2.1 cm²/cm³.

The support/supported catalyst, such as a support/supported catalyst having a diameter or largest dimension of ≤7 mm, such as ≤7 mm to ≥5 mm, may have a side crush strength of ≥6 kgf, such as ≥8 kgf, preferably ≥10 kgf, and/or may have a side crush strength of ≥30 kgf, preferably ≥40 kgf, more preferably ≥50 kgf, most preferably ≥60 kgf or ≥70 kgf.

The support/supported catalyst, such as a support/supported catalyst having a diameter or largest dimension of ≤10 mm to ≥5 mm, or packed bed, may have a GSA of ≥1.2 cm²/cm³, such as ≥1.5 cm²/cm³, preferably a GSA of ≥1.7 cm²/cm³, more preferably a GSA of ≥1.9 cm²/cm³, most preferably a GSA of ≥2.1 cm²/cm³.

The support/supported catalyst, such as a support/supported catalyst having a diameter or largest dimension of ≤10 mm to ≥5 mm, may have a side crush strength of ≥26 kgf, such as ≥10 kgf, preferably ≥12 kgf, and/or may have a side crush strength of ≥30 kgf, preferably ≥50 kgf, more preferably ≥70 kgf, most preferably ≥80 kgf or ≥90 kgf.

The support/supported catalyst, such as a support/supported catalyst having a diameter or largest dimension of ≥8 mm, or >9 mm, such as ≤17 mm to ≥8 mm, may have a GSA of ≥0.7 cm²/cm³ and a side crush strength of ≥10 kgf. Within this range, the support/supported catalyst may have a geometric surface area per volume (GSA) of ≥1 cm²/cm³, preferably a GSA of ≥1.2 cm²/cm³, more preferably a GSA of ≥1.3 cm²/cm³, most preferably a GSA of ≥1.4 cm²/cm³, and a side crush strength of ≥12 kgf, more preferably ≥15 kgf. The support/supported catalyst, such as a support/supported catalyst having a diameter or largest dimension of ≥8 mm, or >9 mm, such as ≥17 mm to ≥8 mm, may have a GSA of ≥0.7 cm²/cm³ and a side crush strength of ≥50 kgf. Within this range, the support/supported catalyst may have a geometric surface area per volume (GSA) of ≥0.7 cm²/cm³, such as a GSA of ≥1 cm²/cm³, preferably a GSA of ≥1.2 cm²/cm³, more preferably a GSA of ≥1.3 cm²/cm³, most preferably a GSA of ≥1.4 cm²/cm³, and a side crush strength of ≥60 kgf, preferably ≥70 kgf, more preferably ≥80 kgf, most preferably ≥85 kgf.

The support/supported catalyst, such as a support/supported catalyst having a diameter or largest dimension of ≤9 mm, such as ≤9 mm to ≥7 mm, may have a GSA of ≥1.3 cm²/cm³ and a side crush strength of ≥8 kgf. Within this range, the support/supported catalyst may have a GSA of ≥1.4 cm²/cm³, preferably a GSA of ≥1.5 cm²/cm³, more preferably a GSA of ≥1.6 cm²/cm³, most preferably a GSA of ≥1.7 cm²/cm³ and a side crush strength of ≥10 kgf, more preferably ≤12 kgf. The support/supported catalyst, such as a support/supported catalyst having a diameter or largest dimension of ≤9 mm, such as ≤9 mm to ≥7 mm, may have a GSA of ≥1.3 cm²/cm³ and a side crush strength of ≥30 kgf. Within this range, the support/supported catalyst may have a GSA of ≥1.4 cm²/cm³, preferably a GSA of ≥1.5 cm²/cm³, more preferably a GSA of ≥1.6 cm²/cm³, most preferably a GSA of ≥1.7 cm²/cm³ and a side crush strength of ≥50 kgf, preferably ≥60 kgf, more preferably ≥70 kgf, most preferably ≥80 kgf.

The support/supported catalyst, such as a support/supported catalyst having a diameter or largest dimension of ≤7 mm, such as ≤7 mm to ≥5 mm, may have a GSA of ≥1.7 cm²/cm³ and a side crush strength of ≥6 kgf. Within this range, the support/supported catalyst may have a GSA of ≥1.8 cm²/cm³, preferably a GSA of ≥1.9 cm²/cm³, more preferably a GSA of ≥2.0 cm²/cm³, most preferably a GSA of ≥2.1 cm²/cm³ and a side crush strength of ≥8 kgf, more preferably ≥10 kgf. The support/supported catalyst, such as a support/supported catalyst having a diameter or largest dimension of ≤7 mm, such as ≤7 mm to ≥5 mm, may have a GSA of ≥1.7 cm²/cm³ and a side crush strength of ≥30 kgf. Within this range, the support/supported catalyst may have a GSA of 1.8 cm²/cm³, preferably a GSA of ≥1.9 cm²/cm³, more preferably a GSA of ≥2.0 cm²/cm³, most preferably a GSA of ≥2.1 cm²/cm³ and a side crush strength of ≥40 kgf, preferably ≥50 kgf, more preferably ≥60 kgf, most preferably ≥70 kgf.

The support/supported catalyst, such as a support/supported catalyst having a diameter or largest dimension of ≤10 mm to ≥5 mm, or packed bed, may have a GSA of ≥1.2 cm²/cm³ and a side crush strength of ≥6 kgf. Within this range, the support/supported catalyst may have a GSA of ≥1.5 cm²/cm³, preferably a GSA of ≥1.7 cm²/cm³, more preferably a GSA of ≥1.9 cm²/cm³, most preferably a GSA of ≥2.1 cm²/cm³ and a side crush strength of ≥10 kgf, more preferably ≥12 kgf. The support/supported catalyst, such as a support/supported catalyst having a diameter or largest dimension of ≤10 mm to ≥5 mm, or packed bed, may have a GSA of ≥1.2 cm²/cm³ and a side crush strength of ≥30 kgf. Within this range, the support/supported catalyst may have a GSA of ≥1.5 cm²/cm³, preferably a GSA of ≥1.7 cm²/cm³, more preferably a GSA of ≥1.9 cm²/cm³, most preferably a GSA of ≥2.1 cm²/cm³ and a side crush strength of ≥50 kgf, more preferably ≥70 kgf, most preferably ≥80 kgf or ≥90 kgf.

GSA per volume herein is calculated by measuring the external dimensions of the support/supported catalyst, including all macrostructure and surface structure features and calculating the surface area. The calculated surface area is then divided by the calculated volume of the support/supported catalyst. Suitable 3D modelling software can be used to provide these calculations.

Side crush strength herein is represented by a value given in kgf. This is the maximum load recorded at the point of failure of the sample when pressed & crushed between two parallel, flat, hardened steel plates of minimum diameter 80 mm. One plate is fixed to a load cell & recording device, and the other is attached to a ram which moves at a controlled rate of 5 mm/minute. Initial trial tests are carried out to determine the dimension in which the support/supported catalyst is weakest. The side crush test is then carried out in the weakest direction.

The support/supported catalyst may have a porosity of ≥0.35 cm³/g, preferably ≥0.40 cm³/g, more preferably ≥0.45 cm³/g, most preferably ≥0.50 cm³/g.

The support/support of the supported catalyst may have a pore size distribution wherein the percentage of total pore volume present in pores having a radius of <0.5 μm is at least 5% such as at least 10% and/or up to 25%, such as up to 20%, such as up to 15%. The support/support of the supported catalyst may have a pore size distribution wherein the percentage of total pore volume present in pores having a radius of from 0.5 to 1 μm is at least 5%, such as at least 10% such as at least 30% and/or up to 50%, such as up to 40%. The support/support of the supported catalyst may have a pore size distribution wherein the percentage of total pore volume present in pores having a radius of from 1 to 5 μm is at least 10% such as at least 20% and/or up to 40%, such as up to 30%. The support/support of the supported catalyst may have a pore size distribution wherein the percentage of total pore volume present in pores having a radius of 5 to 10 μm is at least 1% such as at least 3% and/or up to 15%, such as up to 10%. The support/support of the supported catalyst may have a pore size distribution wherein the percentage of total pore volume present in pores having a radius of 10 to 30 μm is at least 1% such as at least 3% and/or up to 15%, such as up to 10%. The support/support of the supported catalyst may have a pore size distribution wherein the percentage of total pore volume present in pores having a radius of 30 to 51 μm is at least 0.3%, such as at least 1%, such as at least 3% and/or up to 15%, such as up to 10%, The support/support of the supported catalyst may have a pore size distribution wherein the percentage of total pore volume present in pores having a radius of >51 μm is at least 1% such as at least 3% and/or up to 20%, such as up to 15%.

Porosity (as defined in cm³/g), which as used herein may also be termed ‘total intruded volume’, was measured by mercury intrusion porosimetry, using ASTM D4284-12(2017)e1, Standard Test Method for Determining Pore Volume Distribution of Catalysts and Catalyst Carriers by Mercury Intrusion Porosimetry. The skilled person may vary the porosity/total intruded volume using any of the normal methodologies of art that, such as use of a suitable ceramic material, suitable amount of pore former and/or amount of monomer.

Advantageously, the support/supported catalyst of the present invention provides improved uniformity in the void space within a packed column while also significantly reducing the flow dead zone relative to the pellet volume. The support/supported catalysts can further provide a combination of desirable properties includes high selectively (such as >90%), long life time (such as 3-4 years), low cost, high attrition and/or high crush strength as desired. Furthermore, the support/supported catalyst provides improved mass transport. The use of high GSA supports increases the activity while keeping the selectivity as high as needed, increasing yield, and thereby increasing plant production rates.

The support/supported catalyst of the present invention can also provide improved geometric surface area whilst still providing improved strength in the production of an alkylene oxide. The support/supported catalyst of the present invention may provide improved geometric surface area in combination with excellent strength and high levels of porosity. The improved geometric surface area of the support/supported catalyst is particularly advantageous for applications in which the catalytic reaction is surface based. Supports/Supported catalysts of the present invention can also provide a high heat transfer co-efficient in combination with other improved properties.

The support/supported catalyst of the present invention may be a cast support/supported catalyst, such as a gel cast support/supported catalyst, suitably by slip casting. Preferably, the surface structures of the support/supported catalyst are formed during the moulding step of the support/supported catalyst, i.e. the step in which the green body of the support/supported catalyst is formed, suitably by appropriate formations provided in the shape of the mould. As such, preferably the surface structures are not post-fabricated after the moulding of the green body of the support/supported catalyst.

The support/supported catalyst may be obtainable by gel casting a composition comprising a ceramic material, an organic binder component and optionally a pore forming component.

The support/supported catalyst may be formed from a cast moulding composition, preferably a gel cast moulding composition. The support/supported catalyst may be formed from a moulding composition comprising an organic binder component, a ceramic material, and optionally a pore forming component.

The organic binder component may be operable to be substantially removed from the support/supported catalyst after moulding of the support/supported catalyst, preferably with heat treatment, more preferably removed during calcination of the support/supported catalyst.

The organic binder component may comprise a polymerisable component, suitably including a polymerisable monomer and a crosslinking member, wherein the binder component is operable to polymerise to from a (co)polymer.

The polymerisable monomer may comprise one or more type of ethylenically unsaturated monomers, such as an acrylic monomer or derivative thereof such as an acrylamide monomer, and/or a vinyl monomer, such as a monomer selected from one or more of methacrylamide (MAM), N-(hydroxymethyl)acrylamide (hMAM), hydroxyethyl acrylamide (hEAM) and/or N-vinyl-2-pyrrolidinone (NVP). Preferably, the polymerisable monomer comprises one or more acrylamide monomers, more preferably a monomer selected from one or more of methacrylamide (MAM), N-(hydroxymethyl)acrylamide (hMAM) and hydroxyethyl acrylamide (hEAM). Most preferably, the polymerisable monomer comprises MAM.

The crosslinking member may be selected from one or more of a diethylenically unsaturated monomer, such as a diacrylic monomer or derivative thereof such as a diacrylamide monomer; an acrylic salt and/or a polyethylene glycol substituted acrylic monomer. The crosslinking member may be selected from one or more of poly(ethylene glycol) dimethacrylate (PEGDMA), N,N′-methylenebis(acrylamide) (BIS), ammonium acrylate and PEG methylethylmethacrylate (PEGMEM), preferably one more of poly(ethylene glycol) dimethacrylate (PEGDMA), and N,N′-methylenebis(acrylamide) (BIS).

The organic binder component may be formed from 40 to 95 wt % of polymerisable monomer and from 60 to 5 wt % of crosslinking member, such as from 50 to 90 wt % of polymerisable monomer and from 50 to 10 wt % of crosslinking member, or from 55 to 85 wt % of polymerisable monomer and from 45 to 15 wt % of crosslinking member, or from 60 to 80 wt % of polymerisable monomer and from 40 to 20 wt % of crosslinking member, such as from 65 to 75 wt % of polymerisable monomer and from 35 to 25 wt % of crosslinking member.

The composition may further comprise a polymerisation accelerator, operable to accelerate the polymerisation of the binder component. The polymerisation accelerator may be any suitable accelerator. For example, the accelerator may be tetramethylethylenediamine (TEMED).

The composition may further comprise an initiator operable to initiate polymerisation of the binder component. The initiator may be any suitable initiator. The initiator may be a free radical initiator. For example, the initiator may be ammonium persulphate and/or potassium persulphate.

The pore forming material may be operable to be removed from the supported catalyst after moulding of the support/supported catalyst, preferably with heat treatment, more preferably during calcination of the support/supported catalyst. The pore forming material may be selected from one or more of microbeads, starch, seeds and/or cellulose.

The ceramic material of the support/supported catalyst or composition may be a refractory ceramic material. The ceramic material may comprise aluminium oxide, aluminium silicate, magnesium aluminate, calcium aluminate, zirconia, silica, titanate, carbon and/or magnesium oxide, or precursors thereof. The ceramic material may comprise aluminium oxide, such as α-aluminium oxide, or precursors thereof.

The ceramic material may have a particle size distribution wherein D₁₀ is from 0.1 to 20 μm, preferably from 0.4 to 10 μm, more preferably from 0.6 to 5 μm, most preferably from 0.8 to 2.5 μm. The D₅₀ of the ceramic material may be from 0.5 to 35 μm, preferably from 5 to 30 μm, more preferably from 8 to 25 μm, most preferably from 10 to 20 μm. The D₉₀ of the ceramic material may be from 10 to 100 μm, preferably from 15 to 80 μm, more preferably from 20 to 70 μm, most preferably from 25 to 60 μm. Advantageously, ceramic material within these particle size distributions may provide improved strength in combination with the required porosity.

The ceramic material may be a ceramic powder. The ceramic powder may be ball milled or spray dried. Advantageously, it has been found that ball milled or spray dried ceramic powder provides easier casting behaviour.

The composition or support/supported catalyst may comprise a promoter, operable to increase the reactivity of the main reaction, and/or decrease undesirable side reactions. The promoter may be selected from one or more of oxides of lanthanum, copper, magnesium, manganese, potassium, calcium, zirconium, barium, cerium, sodium, lithium, molybdenum, yttrium, cobalt, and chromium.

The composition may further comprise a carrier, such as aqueous carrier. Suitably the composition is an aqueous ceramic slurry.

The composition may comprise further additives. For example, the composition may comprise a dispersant, such as a polymeric salt, for example a salt of a polyacrylic, preferably an ammonium salt of a polyacrylic. A suitable dispersant may be selected from one or more of Ecodis P90, Narlex LD42 and Dispex A40.

The composition may comprise from 0.1 to 10% of polymerisable monomer by dry weight of the composition, preferably from 0.5 to 8 wt %, more preferably from 1 to 6 wt %, such as from 1.5 to 5 wt %, most preferably from 2 to 4 wt %.

The composition may comprise from 0.1 to 10% of crosslinking member by dry weight of the composition, preferably from 0.5 to 8 wt %, more preferably from 0.75 to 6 wt %, such as from 1 to 5 wt %, most preferably from 1 to 4 wt %.

The composition may comprise from 50 to 95% of ceramic material by dry weight of the composition, preferably from 50 to 90 wt %, more preferably from 55 to 85 wt %, most preferably from 60 to 80 wt %. The supported catalyst may comprise at least 75% of ceramic material by dry weight of the composition, preferably at least 85 wt %, more preferably at least 90 wt %, such as at least 95 wt %, most preferably at least 97 wt % ceramic material.

The ceramic material of the support/supported catalyst or composition may comprise ≥50% aluminium oxide by weight of the ceramic material, such as ≥75 wt % aluminium oxide, or ≥90 wt % aluminium oxide, ≥95 wt % aluminium oxide, or ≥99 wt % aluminium oxide.

The support/supported catalyst may comprise ≥50% aluminium oxide by weight of the ceramic material, such as ≥75 wt % aluminium oxide, or ≥80 wt % aluminium oxide, ≥85 wt % aluminium oxide, or ≥90 wt % aluminium oxide.

The composition may comprise from >0 to 40% of pore forming member by dry weight of the composition, preferably from 0.5 to 30 wt %, more preferably 2 to 25 wt %, such as from 3 to 20 wt %, most preferably from 4 to 15 wt %.

The composition may comprise from 0.1 to 5% of initiator by dry weight of the composition, preferably from 0.5 to 4 wt %, more preferably from 0.75 to 3.5 wt %, most preferably from 1 to 3 wt %.

The composition may comprise up to 5% of accelerator by dry weight of the composition, preferably up to 3 wt %, more preferably up to 2 wt %, most preferably up to 1.5 wt %.

The composition may comprise from 0.1 to 10% of dispersant by dry weight of the composition, preferably from 0.5 to 8 wt %, more preferably 0.75 to 6 wt %, most preferably from 1 to 5 wt %.

The composition may have a solids content of from 45 to 99% by total weight of the composition, such as from 50 to 95 wt %, preferably from 55 to 90 wt %, most preferably from 60 to 85 wt %.

The composition may be formed by combining a pre-formed aqueous binder component with a ceramic composition. Suitably the aqueous binder component comprises a polymerisable monomer, a crosslinking member and water.

The supported catalyst of the present invention comprises catalytic material. The catalytic material is operable to provide catalytic activity in the production of an alkylene oxide.

The catalytic material may comprise a metal, such as a noble metal, for example gold, platinum, rhodium, palladium, ruthenium, rhenium, and/or silver; and/or a base metal such as copper, chromium, iron, cobalt, nickel, zinc, manganese, vanadium, titanium and/or scandium. Typically, the catalytic material may comprise a noble metal, such as silver.

The supported catalyst may comprise catalytic material in an amount of ≥5% by weight of the supported catalyst, such as ≥7 wt % or ≥10 wt %. The supported catalyst may comprise catalytic material in an amount of ≤30% by weight of the supported catalyst, such as ≤25 wt % or ≤20 wt %. The supported catalyst may comprise catalytic material in an amount of from 5 to 30% by weight of the supported catalyst, such as from 7 to 25 wt % or from 10 to 20 wt %.

The support/supported catalyst may be for use in a packed-bed reactor for the production of an alkylene oxide such as ethylene oxide, 1,9-decadiene oxide, 1,3-butadiene oxide, 2-butene oxide, isobutylene oxide, 1-butene oxide and/or propylene oxide, suitably for ethylene oxide.

According to a third aspect of the present invention there is provided a method for producing a support and optionally a supported catalyst, suitably a support or supported catalyst according to the first or second aspect of the present invention, comprising the steps of:
a. contacting a composition for producing a support/supported catalyst, suitably a gel cast composition as defined in relation to the first and second aspect, with an initiator and optionally a polymerisation accelerator;
b. arranging the resulting composition of step (a) in a mould;
c, demoulding the composition to produce a green body,
d. optionally, drying the green body at room temperature or baking the green body at elevated temperature;
e. calcining the green body;
f. optionally, contacting the support with catalytic material.

The composition may be mixed before arranging in the mould to form a homogeneous slurry, suitably before addition of initiator and the optional accelerator. The composition may be mixed after addition of the initiator and the optional accelerator to form a homogeneous slurry.

The mould is preferably a cast mould. The mould may be operable to form surface structures on the green body.

The green body produced by step (c) may be dried by baking the green body at ≥40° C., such as ≥50° C. or ≥55° C. or ≥60° C. The green body produced by step (c) may be dried by baking the green body at ≥70° C., such as ≥80° C. or ≥90° C. Suitably, the green body may be baked for ≥10 hours, such as ≥15 hours or ≥20 hours, for example ≥≥24 hours.

The green body may be calcined at ≥1000° C., preferably ≥1200° C., more preferably ≥1400° C., most preferably ≥1500° C. Suitably, the green body is fired until substantially all of the binder and pore forming component has been removed from the support/supported catalyst.

Advantageously, the present invention enables the green support/supported catalyst body to be removed from the mould while it is in a form that is still relatively rubbery, allowing for easier handling. This leads to a lower scrap rate than other types of casting techniques.

The catalytic material may be arranged onto the support by any suitable method. The catalytic material may be applied by solution impregnation, physical vapor deposition, chemical vapor deposition or other suitable technique. Typically, by solution impregnation.

An aqueous solution of the catalytic material may be used. For example, a suitable solution may comprise a solution of a silver lactate or silver oxalate (for example through reaction of silver hydroxide with oxalic acid, or reaction of silver nitrate or silver oxide with ammonium oxalate). The surface tension of the solution may be adjusted with a suitable surfactant, such as laurylamine ethoxylate. The solution may have a surface tension of <50 mN/m.

The solution may be applied to the support by dipping the support into the solution. The support may be dried at a temperature of from 105° to 150° C. The support may be then be calcined, suitably in air, for example at a temperature of from 550 to 600° C.

The catalytic material may be arranged directly on the surface of the support or may be bound to an intermediate layer, such as a washcoat. The catalytic material may also be covalently attached to a macromolecular species, such as synthetic polymer or a biopolymer, such as a protein or nucleic acid polymer, which may then be arranged either directly to the surface of the support or on an intermediate layer.

The solution or support/supported catalyst may comprise an amino compound, which may act as a complex forming agent. The inclusion of an amino compound can improve decomposition of the metal salts into well dispersed and fine particles. The amino compound may be selected from ethyldiamine, monoethanolamine and/or diethanolamine.

The solution or support/supported catalyst may comprise an additive, such as a promoter. As used herein, “a promoter” can be considered to be a component that improves an aspect of catalyst performance or otherwise promote the production of the desired product. A promoter is not typically a catalytic material.

The promoter may be selected from an alkali metal or alkali earth metal, such as rubidium, potassium, lithium, sodium, and/or caesium; and/or from a transition metal, such as rhenium, molybdenum, tungsten and/or manganese. Suitably, the promoter may be selected from rubidium and/or caesium.

The solution may comprise a promoter in an amount of from 0.01 to 0.05% by weight of the solution.

According to a fourth aspect of the present invention there is provided a method for producing a support or a supported catalyst, suitably a support or supported catalyst according to the first or second aspect of the present invention, the method comprising the steps of:
a. optionally, producing a digital model of a support/supported catalyst;
b. producing a precursor according to the model using additive manufacturing, preferably printing with a 3D printer;
c. forming a cast mould from the precursor;
d. cast moulding a moulding composition, suitably a moulding composition as defined in relation to the first or second aspect, to form a support or supported catalyst; suitably according to the method of the third aspect of the present invention.

According to a fifth aspect of the present invention there is provided a reactor for the production of an alkylene oxide comprising a catalyst bed wherein the catalyst bed comprises a support according to the first aspect of the present invention and/or a supported catalyst according to the second aspect of the present invention.

The reactor may comprise a plurality of reactor tubes comprising a support and/or supported catalyst according to the present invention, suitably ≥500 reactor tubes, such as ≥1000 Reactor tubes.

According to a sixth aspect of the present invention there is provided a reactor tube for the production of an alkylene oxide comprising a catalyst bed wherein the catalyst bed comprises a support according to the first aspect of the present invention and/or a supported catalyst according to the second aspect of the present invention.

The reactor tube may have a height of from 2 to 25 meters, such as from 4 to 20 meters or from 6 to 15 meters. The reactor tubes may have a diameter of from 5 to 100 mm, such as from 10 to 75 mm or from 15 to 60 mm.

According to a seventh aspect of the present invention there is provided a reaction medium for the production of an alkylene oxide comprising a catalyst bed wherein the catalyst bed comprises a support according to the first aspect of the present invention and/or a supported catalyst according to the second aspect of the present invention.

The reaction medium may further comprise an alkylene and oxygen or air. The alkylene may be selected from ethylene, 1,9-decadiene, 1,3-butadiene, 2-butene, isobutylene, 1-butene and/or propylene, suitably ethylene.

The reaction medium may comprise a diluent, such as methane, argon and/or N₂, suitably methane and/or argon when oxygen is used and N₂ when air is used.

The reaction medium may further comprise carbon dioxide.

The reaction medium may have a temperature of from 200 to 300° C., such as from 200 to 275° C., or from 240 to 275° C.

The reaction medium may have a pressure of from 1 to 3 MPa.

The reaction medium may have a gas hourly space velocity (GHSV) of from 2,000 to 4,500 h-.

According to an eighth aspect of the present invention, there is provided a method for the production of an alkylene oxide comprising the use of a reactor comprising a catalyst bed wherein the catalyst bed comprises a support according to the first aspect of the present invention and/or a supported catalyst according to the second aspect of the present invention to produce an alkylene oxide.

The method may comprise contacting an alkylene and oxygen/air with the supported catalyst. The alkylene may be selected from ethylene, 1,9-decadiene, 1,3-butadiene, 2-butene, isobutylene, 1-butene and/or propylene, suitably ethylene.

The method may comprise forming a reaction medium according to the seventh aspect of the present invention.

According to a ninth aspect of the present invention, there is provided apparatus for the production of an alkylene glycol comprising a reactor for the production of an alkylene oxide according to fifth aspect of the present invention and a reactor for the production of alkylene glycol using the alkylene oxide produced from the alkylene oxide reactor.

According to a tenth aspect of the present invention, there is provided a method for the production of an alkylene glycol comprising producing an alkylene oxide according to the eighth aspect of the present invention and then using the produced alkylene oxide in the production of the alkylene glycol.

As used herein, unless otherwise expressly specified, all numbers such as those expressing values, ranges, amounts or percentages may be read as if prefaced by the word “about”, even if the term does not expressly appear. The term “about” when used herein means +/−10% of the stated value. Also, the recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Also, any numerical range recited herein is intended to include all sub-ranges subsumed therein.

Singular encompasses plural and vice versa. For example, although reference is made herein to “an” organic binder component, “a” ceramic material, “a” pore forming component, and the like, one or more of each of these and any other components can be used. As used herein, the term “polymer” refers to oligomers and both homopolymers and copolymers, and the prefix “poly” refers to two or more. Including, for example and like terms means including for example but not limited to. The terms “comprising”, “comprises” and “comprised of” as used herein are synonymous with “including”, “includes” or “containing”, “contains”, and are inclusive or open-ended and do not exclude additional, non-recited members, elements or method steps. Additionally, although the present invention has been described in terms of “comprising”, the processes, materials, and coating compositions detailed herein may also be described as “consisting essentially of” or “consisting of”.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

Where ranges are provided in relation to a genus, each range may also apply additionally and independently to any one or more of the listed species of that genus. For example, the composition may comprise from 0.1 to 10% of polymerisable monomer, by total dry weight of the composition, which polymerisable monomer comprises methacrylamide in an amount such that the composition comprises from 0.1 to 10% of methacrylamide, by total dry weight of the composition. Similarly, the composition may comprise from 0.1 to 10% of polymerisable monomer, by total dry weight of the composition, which polymerisable monomer comprises methacrylamide and hydroxyethyl acrylamide in an amount such that the composition comprises from 0.1 to 10% of methacrylamide and hydroxyethyl acrylamide, by total dry weight of the composition. A further example may be wherein the composition comprises from 0.1 to 10% of polymerisable monomer, by total dry weight of the composition, which polymerisable monomer comprises methacrylamide and hydroxyethyl acrylamide in an amount such that the composition comprises 0.1% of methacrylamide, by total dry weight of the composition. Further, for example, the invention may comprise from 0.1 to 10% of polymerisable monomer, by total solid weight of the composition, which polymerisable monomer comprises methacrylamide and hydroxyethyl acrylamide in an amount such that the composition comprises ≤6% of methacrylamide, by total solid weight of the composition. Further examples of the above mentioned include the ranges provided for the organic binder, the crosslinking member, the ceramic material, the pore forming member, the initiator, the accelerator, and the dispersant, and all associated species, sub-genera and sub species.

All of the features contained herein may be combined with any of the above aspects in any combination.

For a better understanding of the invention, and to show how embodiments of the same may be carried into effect, reference will now be made, by way of example, to the following experimental data and figures.

### BRIEF DESCRIPTION OF DRAWINGS

FIG. 1 shows a perspective view of a first comparative supported catalyst.

FIG. 2 shows a perspective view of a second comparative supported catalyst

FIG. 3 shows a perspective view of a first embodiment of a supported catalyst according to the present invention.

FIG. 4 shows a perspective view of a second embodiment of a supported catalyst according to the present invention.

FIG. 5 shows the flow results for the first comparative supported catalyst with a cross-section of the side of the column along the lateral X axis.

FIG. 6 shows the flow results for the first comparative supported catalyst with a cross-section from the top of the column along the longitudinal Z axis.

FIG. 7 shows the flow results for the second comparative supported catalyst when the intra-particle flow channel is aligned with the direction of flow with a cross-section from the side of the column along the lateral X axis.

FIG. 8 shows the flow results for the second comparative supported catalyst when the intra-particle flow channel is aligned with the direction of flow with a cross-section from the side of the column along the lateral Y axis.

FIG. 9 shows the flow results for the second comparative supported catalyst when the intra-particle flow channel is aligned with the direction of flow with a cross-section from the top of the column along the longitudinal Z axis.

FIG. 10 shows the flow results for the second comparative supported catalyst when the intra-particle flow channel is at 90° to the direction of flow with a cross-section from the side of the column along the lateral X axis.

FIG. 11 shows the flow results for the second comparative supported catalyst when the intra-particle flow channel is at 90° to the direction of flow with a cross-section from the side of the column along the lateral Y axis of.

FIG. 12 shows the flow results for the second comparative supported catalyst when the intra-particle flow channel is at 90° to the direction of flow with a cross-section from the top of the column along the longitudinal Z axis.

FIG. 13 shows the flow results for the second comparative supported catalyst when the intra-particle flow channel is at 45° to the direction of flow with a cross-section from the side of the column along the lateral X axis.

FIG. 14 shows the flow results for the second comparative supported catalyst when the intra-particle flow channel is at 45° to the direction of flow with a cross-section from the side of the column along the lateral Y axis.

FIG. 15 shows the flow results for the second comparative supported catalyst when the intra-particle flow channel is at 45° to the direction of flow with a cross-section from the top of the column along the longitudinal Z axis.

FIG. 16 shows the flow results for the first embodiment of a supported catalyst according to the present invention with a cross-section from the side of the column along lateral axis X.

FIG. 17 shows the flow results for the first embodiment of a supported catalyst according to the present invention with a cross-section from the top of the column along longitudinal axis Z.

FIG. 18 shows the flow results for the second embodiment of a supported catalyst according to the present invention with a cross-section from the side of the column along lateral axis X.

FIG. 19 shows the flow results for the second embodiment of a supported catalyst according to the present invention with a cross-section from the top of the column along longitudinal axis Z.

### DESCRIPTION OF EMBODIMENTS

Computational fluid dynamics (CFD) compared the performance of two comparative supported catalysts to a supported catalyst according to the present invention.

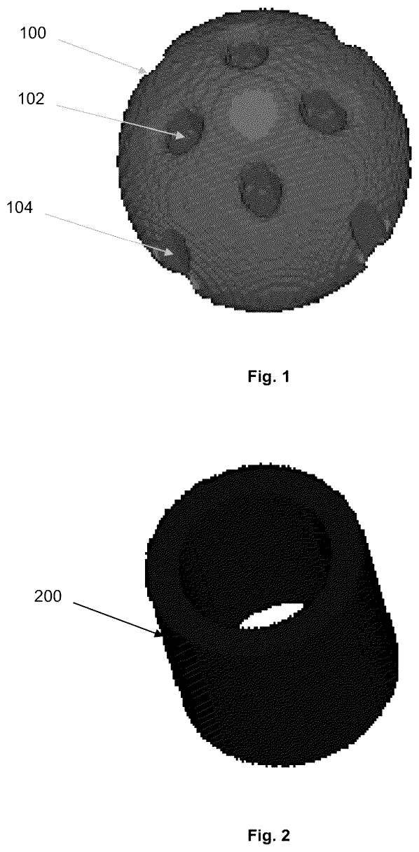

The first comparative supported catalyst 100, shown in FIG. 1, has a 16 mm diameter grooved spherical macrostructure with four equally spaced parallel fluid communication intra-particle channels in the form of bores 102 extending between apertures on opposite sides of the outer surface of the supported catalyst. The grooves 104 of supported catalyst 100 are in the form of four equally spaced parallel linear grooves with curved lateral cross-sections on the outer surface of the supported catalyst. The outer surface of the supported catalyst 100 has the expected smooth continuous curvature of a spherical macrostructure.

The second comparative supported catalyst 200, shown in FIG. 2, is known as a Rashig ring and is in the form of an 8 mm by 8 mm cylinder having a central linear intra-particle fluid channel extending from an aperture in the upper face to and aperture in the lower face. The outer surface of the supported catalyst 200 has the expected smooth continuous curvature of a cylinder macrostructure.

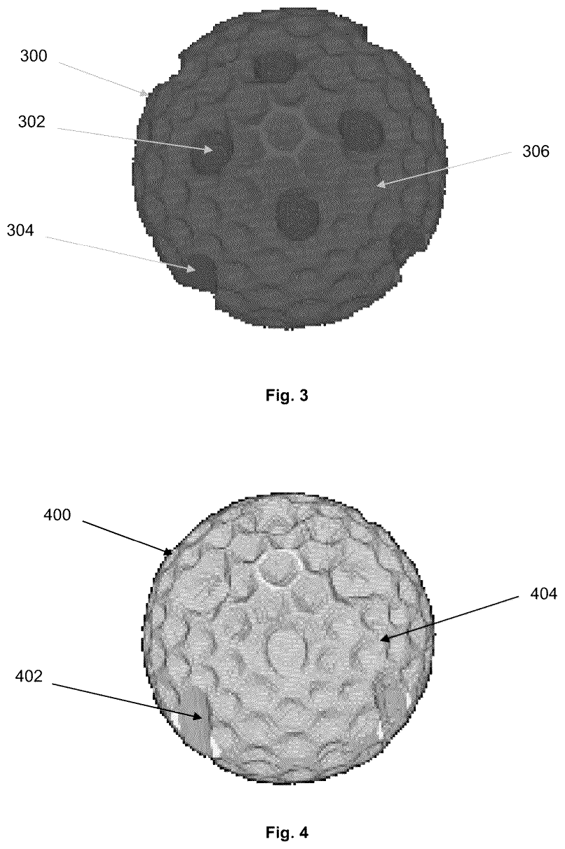

The first embodiment of a supported catalyst 300 according to the present invention, shown in FIG. 3, is the same as the first comparative supported catalyst, with bores 302 and grooves 304, but in addition the outer surface of supported catalyst 300 comprises surface structures in the form of a plurality of interconnected hexagon-shaped annular ridged surface structures 306 extending over substantially the whole of the outer surface apart from the apertures of bores 302 and the surface of grooves 304. The portion of the outer surface that extends between the inner edges of the annular ridges is formed of an open ended inverted hexagonal pyramid.

The second embodiment of a supported catalyst according to the present invention 400, shown in FIG. 4, is the same as the second comparative supported catalyst, with grooves 402 and surface structures 404, except that supported catalyst 400 does not have fluid communication intra-particle channels extending through the body of the supported catalyst.

The supports of the first and second embodiments were produced from a moulding composition formed by mixing the components provided below using the following method.

An aqueous monomer solution containing the chain forming monomer, the chain linking monomer and the water was formed. To this dispersant was added. The pore former was then introduced and mixed until fully dispersed. The alumina powders were then mixed to form an aqueous slurry. The catalyst and initiator were then added to the aqueous slurry. The amounts of each component in the resulting slurry were:

| | % |
|---|---|
| Alumina powder* | 58.0 |
| Pore former | 1.8 |
| Dispersant | 2.0 |
| Polymerisable monomer | 3.7 |
| Crosslinking member | 1.8 |
| Catalyst | 0.3 |
| Initiator | 1.1 |
| Water | 31.3 |

*D₁₀ of 1.32 μm, D₅₀ of 18.7 μm, D₉₀ of 44.2 μm

The resulting aqueous slurry was then cast into a mould having the negative impressions operable to form surface structures on the moulded support. Once the slurry had gelled into a solid green body after 4-5 mins it was then demoulded. At this point the green body support had a rubbery, jelly-like consistency. The green body was then dried at 110° C. for 24 hours. The dried green body was then fired to 1450° C., at which point the binder, dispersant and pore former were burnt off to leave a solid, porous, supported catalyst.

The supports had a porosity/total intruded volume of 0.45 cm³/g and a side crush strength of 15 kg. The support of the first embodiment had a GSA of 493.8 mm².

CFD was used to test the flow around the above-mentioned supported catalysts.

The test conditions were as follows:
Large tube diameter selected so as to not interfere with flow around pellet (50 mm ID)
Simulation resolution 0.125 mm per pixel
Flow rate: 0.4 m³/min
Orientation of the holes/side-channels in the same direction of flow

The result of the flow tests were:

Measured stagnant velocity zone below pellet (truncated cone)

| | | Comp. 2 | | | | |
|---|---|---|---|---|---|---|
| | Comp. 1 | With flow | At 90° | At 45° | Ex. 1 | Ex. 2 |
| Height of dead | 7.5 | 3.4 | 7.3 | 9.8 | 7.4 | 7.25 |
| zone below pellet | | | | | | |
| (mm) | | | | | | |
| Volume of dead | 246.39 | 160.6 | 191.5 | 210.5 | 147.55 | 167.65 |
| zone | | | | | | |
| (mm³) | | | | | | |
| Domain avg | 0.05082 | 0.05015 | 0.05011 | 0.05010 | 0.05088 | 0.05095 |
| velocity | | | | | | |
| Re | 1414.8 | 1382.6 | 1382.6 | 1382.6 | 1416.5 | 1330.3 |
| Dead zone ht | 46.88 | 42.50 | 91.25 | 122.5 | 46.09 | 45.31 |
| relative to pellet | | | | | | |
| diameter, % | | | | | | |
| Dead zone vol | 13.14 | 56.39 | 67.24 | 73.91 | 8.55 | 8.79 |
| relative to pellet | | | | | | |
| vol, % | | | | | | |

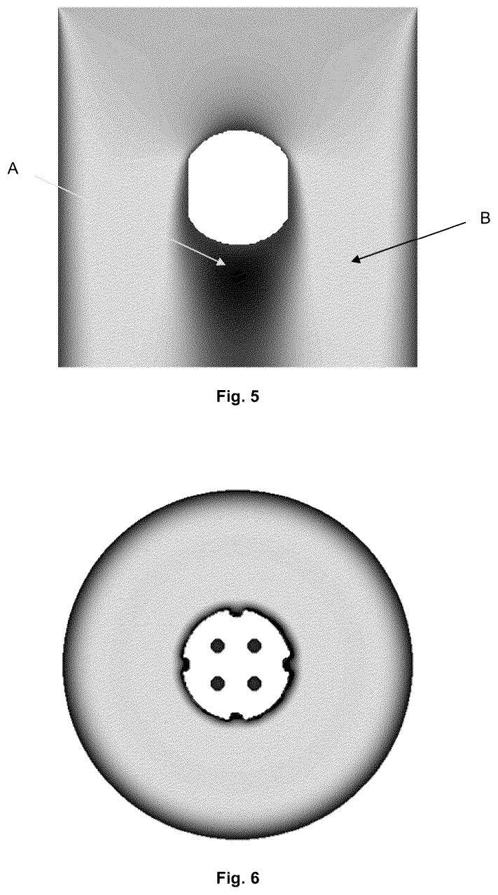

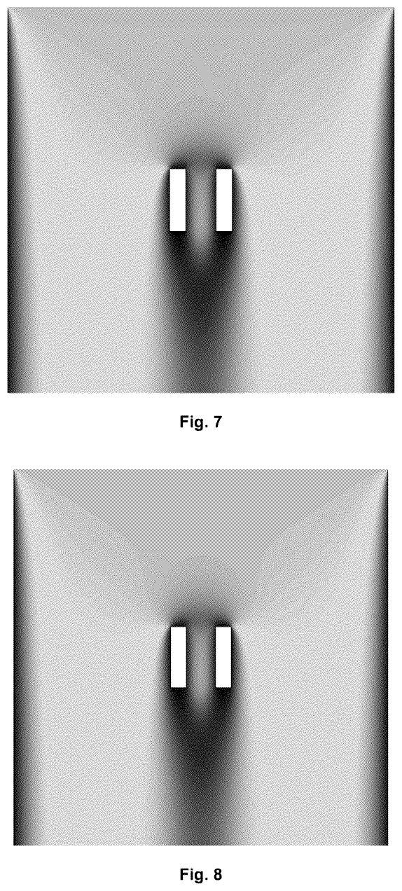

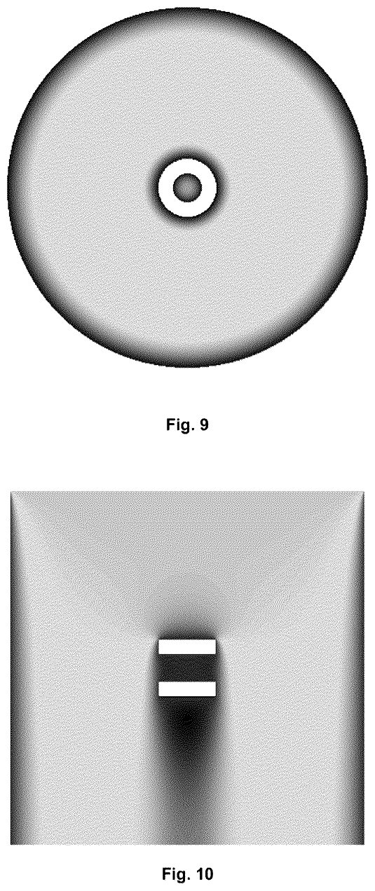

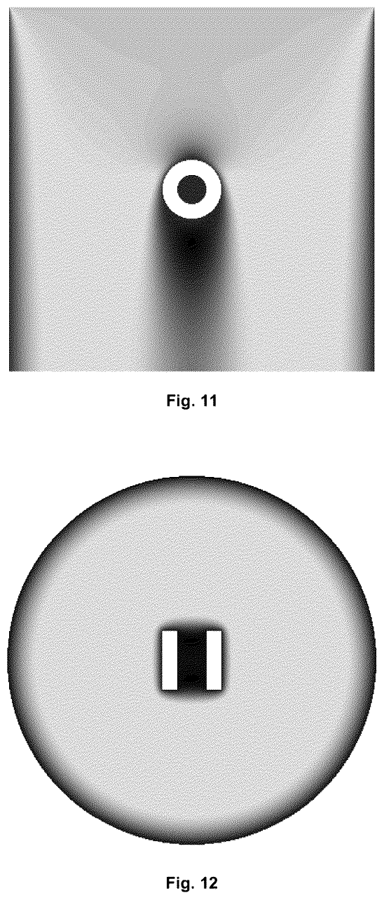

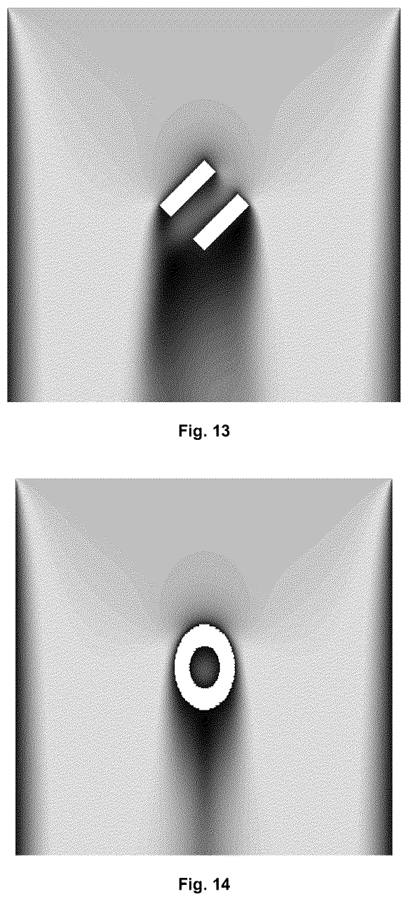

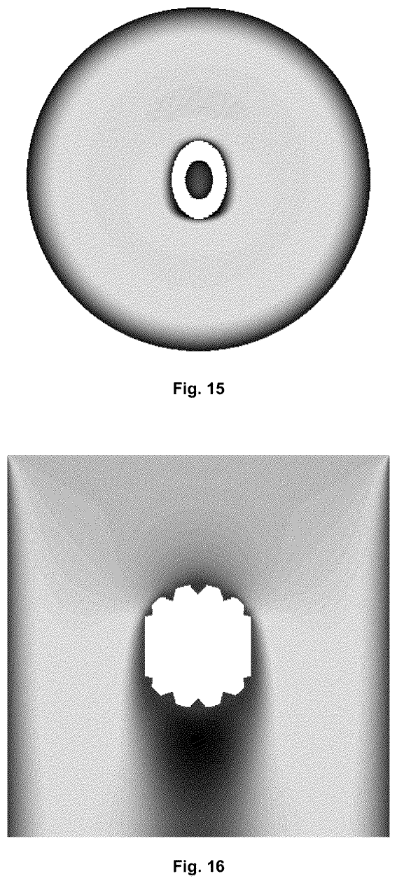

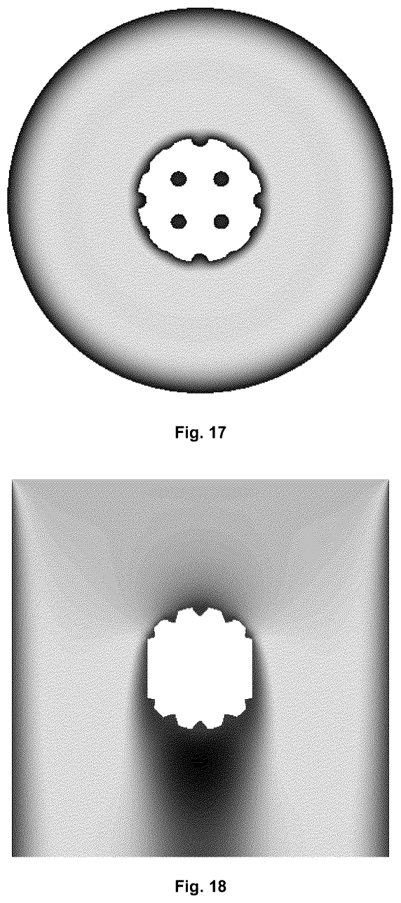

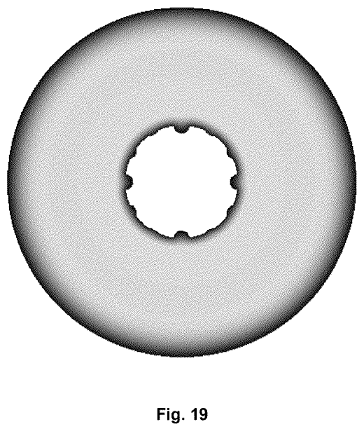

As shown by the results of the above table and in FIGS. 5 to 19, compared to the comparative supported catalysts, the supported catalysts according to the invention provides a higher gas velocity in contact with the supported catalyst. In FIGS. 5 to 19, darker areas such as “A” in FIG. 5 indicate a lower/static gas velocity and lighter areas such as “B” in FIG. 5 indicate a higher gas velocity. In addition, the supported catalysts according to the invention provides a higher amount of gas turbulence above the supported catalyst, and also provides a smaller velocity static zone below supported catalyst.

Furthermore, for the second comparative example, it can be seen that the pellet orientation has a significant effect on the size of the dead zone (see the darkest shading below the pellet). When the pellet is orientated at 45° to the direction of flow, the dead zone volume increases from ˜50 of total pellet volume (when flow aligned) to ˜75% of pellet volume. The dead zone height is even more significantly affected, going from 43% of pellet diameter (when flow aligned) to ˜123% (45°). This would have significant effect in a packed bed on the pellets directly below those at such an angle, reducing the catalyst-gas contact.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A support for a catalyst, wherein the support comprises ceramic material, and wherein the support has a substantially spherical or ellipsoidal macrostructure and comprises surface structures, and wherein the support has a porosity of ≥0.35 cm³/g.

2. A supported catalyst for use in a packed-bed reactor for the production of an alkylene oxide, wherein the supported catalyst comprises ceramic material, and wherein the supported catalyst has a substantially spherical or ellipsoidal macrostructure and comprises surface structures.

3. The support according to claim 1, wherein the macrostructure of the support is substantially in the form of a sphere.

4. The support according to claim 1, wherein the support does not comprise a fluid communication intra-particle channel extending through the support from a first aperture on a first side of the support to a second aperture on a substantially opposing second side of the support.

5. The support according to claim 1, wherein the support/supported catalyst comprises a plurality of repeating surface structures having substantially the same shape.

6. The support according to claim 1, wherein, the support/supported catalyst comprises at least 5 repeating surface structures.

7. The support according to claim 1, wherein the surface structure comprises a ridge, trough, mound and/or depression.

8. (canceled)

9. (canceled)

10. The support according to claim 1, wherein the support/supported catalyst, such as a support/supported catalyst having a diameter or largest dimension of ≤8 mm.

11. The support according to claim 1, wherein the support/supported catalyst has a geometric surface area per volume (GSA) of ≥0.7 cm²/cm³.

12. (canceled)

13. The support according to claim 1, wherein the support/supported catalyst has a side crush strength of ≥8 kgf.

14. (canceled)

15. (canceled)

16. (canceled)

17. (canceled)

18. The supported catalyst according to any of claim 2, wherein the supported catalyst has a porosity of ≥0.35 cm³/g.

19. (canceled)

20. The support according to claim 1, wherein the support is a cast support.

21. (canceled)

22. (canceled)

23. The support according claim 1, wherein the ceramic material has a D₁₀ of from 0.1 to 20 μm, a D₅₀ of from 0.5 to 35 μm, or a D₉₀ of from 10 to 100 μm.

24. (canceled)

25. (canceled)

26. (canceled)

27. (canceled)

28. (canceled)

29. The supported catalyst according to claim 2, wherein the catalytic material comprises a metal.

30. (canceled)

31. The support according to claim 1, wherein the support/supported catalyst is for use in a packed-bed reactor for the production of ethylene oxide, 1,9-decadiene oxide, 1,3-butadiene oxide, 2-butene oxide, isobutylene oxide, 1-butene oxide or propylene oxide.

32. (canceled)

33. A method for producing a support or a supported catalyst comprising the steps of:
a. contacting a composition for producing a support/supported catalyst, suitably a gel cast composition as defined in claim 20, with an initiator and optionally a polymerisation accelerator;
b. arranging the resulting composition of step (a) in a mould;
c. demoulding the composition to produce a green body;
d. optionally, drying the green body at room temperature or baking the green body at elevated temperature;
e. calcining the green body;
f. optionally, contacting the support with catalytic material.

34. A reactor for the production of an alkylene oxide comprising a catalyst bed wherein the catalyst bed comprises a support according to claim 1.

35. (canceled)

36. A reactor tube or reaction medium for the production of an alkylene oxide comprising a catalyst bed wherein the catalyst bed comprises a support according to claim 1.

37. (canceled)

38. A method for the production of an alkylene oxide comprising the use of a reactor comprising a catalyst bed wherein the catalyst bed comprises a support according to claim 1 to produce an alkylene oxide.

39. (canceled)

40. The method for the production of an alkylene glycol comprising producing an alkylene oxide according to claim 38 and then using the produced alkylene oxide in the production of the alkylene glycol.
